(19) United States
(12) Patent Application Publication
(10) Pub. No.: US 2014/0375671 A1
(43) Pub. Date: Dec. 25, 2014

(54) METHOD, SYSTEM, SOFTWARE AND MEDIUM FOR ADVANCED IMAGE-BASED ARRAYS FOR ANALYSIS AND DISPLAY OF BIOMEDICAL INFORMATION

(71) Applicant: UNIVERSITY OF CHICAGO, Chicago, IL (US)

(72) Inventors: Maryellen Giger, Elmhurst, IL (US); Li Lan, Hinsdale, IL (US); Hui Li, Naperville, IL (US)

(73) Assignee: UNIVERSITY OF CHICAGO, Chicago, IL (US)

(21) Appl. No.: 14/361,122

(22) PCT Filed: Nov. 28, 2012
(86) PCT No.: PCT/US2012/066806

§ 371 Date: May 28, 2014

Related U.S. Application Data
(60) Provisional application No. 61/564,150, filed on Nov. 28, 2011.

(51) Int. Cl. G06T 7/00; G06F 17/30; G09G 5/06

(52) U.S. Cl. CPC G06T 7/0014; G09G 5/06; G06F 17/30256; G06F 17/3025; G06T 2207/10116; G06T 2207/30068; G06T 2207/30096
USPC 345/589; 382/132

(57) ABSTRACT

An image array includes pixels, each representing an image-based feature value of a patient obtained from imaging. The array includes first and second dimensions. Pixels corresponding to a specific patient of a plurality of patients extend in the first dimension and pixels corresponding to a specific feature of a plurality of features extend in the second dimension. Patients represented in the image array are grouped into two or more groups. Each indicates a known condition, such that patients having a first and second conditions are respectively part of a first and a second group and are in a first and a second portion of the array, respectively. The groups are separately organized according to a selected feature. Patients of the first and second groups are respectively arranged in an order of values for the selected feature within the first and second portions.

### CROSS-REFERENCE TO RELATED APPLICATIONS

This application claims priority to and incorporates herein by reference the entirety U.S. App. No. 61/564,150, filed Nov. 28, 2011.

### BACKGROUND

1. Field of Disclosure

This disclosure relates generally to the fields of quantitative image analysis and genomics including the discovery, analysis, interpretation, and display of image-based arrays to aid in medical decision making and biological discovery. Such systems can indicate, e.g., a feature value (e.g., characteristic; image-based biomarker; image-based phenotype), a dimension reduced feature (pseudo feature), or an estimate of a probability of disease state (PM) (which can be a characteristic of normal, a probability of malignancy, cancer subtypes, risk, prognostic state, and/or response to treatment), usually determined by training a classifier on datasets. Output from such analysis can be used as an image-based “gene test” where the image-extracted features serve as phenotypes of the gene expression, and can be obtained from, e.g., radiological, histological tissue, molecular, and/or cellular imaging of human or non-human patients/subjects.

2. Discussion of the Background

Breast cancer is a leading cause of death in women, causing an estimated 46,000 deaths per year. Mammography is an effective method for the early detection of breast cancer, and it has been shown that periodic screening of asymptomatic women does reduce mortality. Many breast cancers are detected and referred for surgical biopsy on the basis of a radiographically detected mass lesion or a cluster of microcalcifications. Although general rules for the differentiation between benign and malignant mammographically identified breast lesions exist, considerable misclassification of lesions occurs with current methods. On average, less than 30% of masses referred for surgical breast biopsy are actually malignant.

The clinical management and outcome of women with breast cancer vary. Various prognostic indicators can be used in management including patient age, tumor size, number of involved lymph nodes, sites of recurrence, disease free interval, estrogen receptor expression, as well as newer biological markers. It has been shown that in many cases biologic features of the primary tumor can be correlated with outcome, although methods of assessing the biologic features may be invasive, expensive or not widely available. Macroscopic lesion analysis via medical imaging has been quite limited for prognostic indication, predictive models, patient management, or as a complement to biomarkers.

Scientists and physicians have used gene expression arrays to indicate biological phenotypes/biomarkers, showing, e.g., signatures of expression of a signature with non-expressors. See, e.g., FIG. 4 in MacDermed D M, Khodarev N N, Pitroda S, Edwards D C, Pelizzari C A, Huang L, Kufe D W, Weichselbaum R R, “MUC1-associated proliferation signature predicts outcomes in lung adenocarcinoma patients”, BMC Medical Genomics 3:16, 2010; and FIG. 4 in Kristensen V N, Vaske C J, Ursini-Siegel J, et al., “Integrated molecular profiles of invasive breast tumors and ductal carcinoma in situ (DCIS) reveal differential vascular and interlukin signaling”, Proc Natl Acad Sci, 2011. PMID: 21908711.

### SUMMARY

Incorporation of image-based phenotypes into image-based arrays has yet to be done for biological discovery and/or medical decision making. Output from such analysis can be used as an image-based “gene test” where the image-extracted features serve as phenotypes of the gene expression, and can be obtained from, e.g., radiological, histological tissue, molecular, and/or cellular imaging. In some aspects, an application of computer vision to this problem is presented here with computer methods to create image-based phenotype arrays for biological discovery and medical decision making such as that concerning a patient's likely diagnosis, prognosis and expected response to therapy from radiological imaging—morphological and functional features serving as aids to, e.g., radiologists, pathologists, and oncologists. Output from such analysis can be used as an image-based “gene test” where the image-extracted features serve as phenotypes of the gene expression, and can be obtained from, e.g., radiological, histological tissue, molecular, and/or cellular imaging.

An automatic or interactive method, system, software, and/or medium for a method and workstation for quantitative analysis of multi-modality breast images can include analysis of, e.g., full-field digital mammography (FFDM), 2D and 3D ultrasound, and MRI. A workstation (e.g., a computer or processing system) can include automatic, real-time methods for the characterization of tumors and background tissue, and calculation of image-based biomarkers (image-based phenotypes) for breast cancer diagnosis, prognosis, and/or response to therapy. A system can be fully automated, and a user can provide an indication of a location of a potential abnormality. This user can be a human user or a computer-aided detection device “user.” The only input required from the “user” is, e.g., a click (or other an indication) on or near the center of the lesion—in any of the modalities—e.g., x-ray, sonography, computed tomography, tomosynthesis and/or MRI. The quantitative analysis includes lesion segmentation—in 2D or 3D, depending on the modality, the extraction of relevant lesion characteristics (such as textural, morphological, and/or kinetic features) with which to describe the lesion, and the use of combinations of these characteristics in several classification tasks using artificial intelligence. Exemplary lesion characteristics are described in U.S. patent application Ser. No. 13/305,495 (US 2012/0189176) and U.S. Pat. No. 7,298,881, both incorporated herein by reference in entirety.

The output can be given in terms of a numerical value of the lesion characteristic or probability of disease state, prognosis and/or response to therapy, and/or from the use of dimension-reduction techniques to determine pseudo features or characteristics of the disease state. These classification task examples can include the distinction between (1) malignant and benign lesions (diagnosis), (2) ductal carcinoma in situ lesions from invasive ductal carcinoma lesions (diagnosis, malignancy grades), (3) malignant lesions with lymph nodes positive for metastasis and those that have remained metastasis-free (prognosis), and/or (4) the description of lesions according to their biomarkers and/or the change between exam dates (therapy response).

In addition, another option in the display of the numerical and/or graphical output is that the output can be modified relative to the disease prevalence under different clinical scenarios. The interactive workstation for quantitative analysis of breast images can provide radiologists with valuable additional information on which to base a diagnosis and/or assess a patient treatment plan. In some aspects, the functionality of the interactive workstation can be integrated into a typical interpretation workflow.

This can impact the area of women's health and specifically that of breast cancer diagnosis and management. The workstation can impact many aspects of patient care, ranging from earlier more accurate diagnosis to better evaluation of the effectiveness of patient treatment plans. Although aspects of this disclosure relate to breast cancer as an example, the methods, system, software, and media are applicable to other cancers and diseases. While many investigators have made great progress in developing methods of computer detection and diagnosis of lesions, methods of incorporating phenotype arrays into the workflow for biological discovery and/or medical decision making have not been described.

Accordingly, an object of this disclosure is to provide a method and system that employs a computer system (e.g., a workstation) for the creation of image-based phenotype (biomarker) arrays for use, e.g., in diagnosis, prognosis, risk assessment, and/or assessing response to therapy, as well in quantitative image analysis in biological discovery. Output from such analysis can be used as an image-based “gene test” where the image-extracted features serve as phenotypes of the gene expression, and can be obtained from, e.g., radiological, histological tissue, molecular, and/or cellular imaging.

Another object is to provide a method to translate image-based features/characteristics of normal states and/or abnormal disease states into a biological array format for use, e.g., in the assessment of disease state (e.g., cancer, cancer subtypes, prognosis, and/or response to therapy) or for use in biological discovery. The image-based characteristics, such as from radiological, histological tissue, molecular, and/or cellular imaging, can be computer-extracted image features, estimated probabilities of malignancy or other disease state, image-based signatures, and/or pseudo features obtained from dimension reduction techniques. Output from such analysis can be used as an image-based “gene test” where the image-extracted features serve as phenotypes of the gene expression, and can be obtained from, e.g., radiological, histological tissue, molecular, and/or cellular imaging. The assessment of a disease state can be applied to an “unknown case,” which generally refers to a patient, such as a new patient, who has, e.g., an unknown or a not-yet-determined condition.

A further object is to provide a method to present, elucidate, and/or display image-based findings of normal and disease states to users such as radiologists, oncologists, surgeons, and/or biological researchers, for use, e.g., in population studies. The methods of presentation can include ranking the patients by disease state while indicating the image-based phenotypes, and other methods to indicate similar image-based phenotypes/signatures.

An additional object is to provide a method to simultaneously view image-based phenotypes and other gene expression/phenotypes and/or genomic data. And if the analysis includes the dimension reduction of characteristics (features) of the lesion (tumor), the structure of the lesion types across a population can be given. Yet a further object is to provide a method for the calculation and/or display of such image-based array information to allow for any varying of the disease state prevalence or prognostic state prevalence.

These and other objects are achieved by providing a method and system that employs a computer, such as a radiology workstation, for the characterization of medical images as well quantitative image analysis to yield image-based biomarkers (image-based phenotypes) arrays.

A workstation or processing system can include one or more processors configured to generate an image array including a plurality of pixels, each of the pixels representing an image-based feature value of a patient obtained from imaging the patient, the image array including first and second dimensions so that pixels corresponding to a specific patient of a plurality of patients extend in the first dimension and pixels corresponding to a specific feature of a plurality of features extend in the second dimension. The display can optionally include a third dimension. The one or more processors can be configured to group the patients represented in the image array into two or more groups, each of the groups indicating a known condition of the patients, such that patients having a first condition are part of a first group and are in a first portion of the array, and patients having a second condition are part of a second group and are in a second portion of the array. The one or more processors can also be configured to organize, separately, each of the groups according to a selected feature of the features, such that the patients of the first group are arranged in an order of values for the selected feature within the first portion, and the patients of the second group are arranged in an order of values for the selected feature within the second portion.

The one or more processors can be further configured to obtain values of the features for a new patient having an unknown condition (herein sometimes referred to collectively as an unknown case), and insert pixels corresponding to the new patient into the array according to a value of the selected feature for the new patient. The inserted pixels can be relatively highlighted to make the inserted pixels relatively easy to identify within the array.

The first and second portions can be separated with respect to the second dimension such that the values for the specific feature extend in the second dimension continuously between the first and second portions. Columns of the image array can extend in the first dimension, and rows of the image array can extend in the second dimension.

A display can be provided to display, in a first display region of the display, the pixels using a colormap (sometimes referred to as a color map). The one or more processors can be further configured to normalize, by a normalizing procedure, the features across the patients to generate the colormap. The normalizing procedure can include quantile normalizing. The normalizing procedure can include a linear normalizing executed after the quantile normalizing. The colormap can be a grayscale colormap.

The one or more processors can be configured to: organize values of the features for a new patient having an unknown condition; insert pixels corresponding to the new patient into the array along the first dimension according to a value of the selected feature for the new patient; and display the resulting colormap in the first display region. The display can include a second display region to display an image selected from the group consisting of: a medical image of the new patient, a subtraction image obtained from medical images of the new patient, a histogram, a kinetic curve, a collection of images of different patients that are similar to the new patient, and textual information describing the new patient.

A memory can be included, which can include data including one more of a medical image, medical image data, and data representative of a clinical examination, where the one or more processors can be configured to extract the features, for one or more of the patients, from the data stored in the memory. The selected feature can be a probability of malignancy. Examples of calculating a probability of malignancy are described in U.S. Pat. No. 6,738,499, U.S. Pat. No. 7,640,051 and U.S. Pat. No. 8,175,351, each of which are incorporated herein by reference in its entirety.

A method, process and/or algorithm can include: generating an image array including a plurality of pixels, each of the pixels representing an image-based feature value of a patient obtained from imaging the patient, the image array including first and second dimensions so that pixels corresponding to a specific patient of a plurality of patients extend in the first dimension and pixels corresponding to a specific feature of a plurality of features extend in the second dimension; grouping the patients represented in the image array into two or more groups, each of the groups indicating a known condition of the patients, such that patients having a first condition are part of a first group and are in a first portion of the array, and patients having a second condition are part of a second group and are in a second portion of the array; and organizing, separately, each of the groups according to a selected feature of the features, such that the patients of the first group are arranged in an order of values for the selected feature within the first portion, and the patients of the second group are arranged in an order of values for the selected feature within the second portion.

Values of the features for a new patient having an unknown condition can be obtained. Pixels corresponding to the new patient can be inserted into the array along the first dimension according to a value of the selected feature for the new patient.

The first and second portions can be separated with respect to the second dimension such that the values for the specific feature extend in the second dimension continuously between the first and second portions. Columns of the image array can extend in the first dimension, and rows of the image array can extend in the second dimension.

Exemplary features can be normalized across the patients to generate a colormap. Each of the pixels of the image array can be displayed using a colormap. The normalizing can be one or more of quantile and linear normalizing. Features can be extracted from one or more of, for one or more of the patients, a medical image, medical image data, and data representative of a clinical examination. The selected feature can be a probability of malignancy.

A non-transitory computer readable storage medium can include executable instructions, which when executed by a processor, cause the processor to execute a process, a method and/or an algorithm according to the above.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates an algorithmic process, by way of a flowchart, for incorporating image-based array analysis into computer interpretation of medical images.

FIG. 2 illustrates an exemplary array generated by an algorithmic process.

FIG. 3 illustrates an exemplary array generated by an algorithmic process noting the use of a prevalence transformation for the color map.

FIG. 4 illustrates an exemplary relationship between color map value and normalized feature value.

FIG. 5 illustrates an image-based array from which the 50:50 color map transformation was obtained, and an extended image-based array in which the color map transformation was modified given the new disease-state prevalence in the enlarged dataset.

FIG. 6 shows an image-based array from which the 50:50 color map transformation was obtained in which half the patients had positive lymph nodes and the other half had negative lymph nodes.

FIG. 7 shows two image-based arrays from which the 50:50 color map transformation was obtained in which half the patients had Grade 3 cancer and the other half had either Grade 1 or Grade 2 cancer.

FIG. 8 shows an image-based array to demonstrate population of women—some known to be at high risk of breast cancer and some at low risk. Note that there is not a 50:50 prevalence.

FIG. 9 shows the use of image-based arrays to demonstrate population of women—some known to be BRCA1 or BRCA2 gene mutation carriers and thus at high risk of breast cancer and some at low risk.

FIG. 10 shows the use of image-based arrays to demonstrate population of women—some known to be at high risk of breast cancer and some at low risk.

FIGS. 11 (a, b, c) show image-based arrays from which the 50:50 color map transformation was obtained to demonstrate a population of breast cancer patients—some who responded to therapy (no event) and some who did not respond (event) (i.e., responders and non-responders), for event vs. no event, for added subcategory of lymph node status, and for added subcategory of tumor grade.

FIG. 12 shows an example of a workstation display for a malignant lesion—showing the segmented lesion on DCE-MRI, the average kinetic and most enhancing kinetic curves, the voxel-based diagnostic colormap, and the lesion's volumetrics of volume, effective diameter, and surface area.

FIGS. 13-14 demonstrate a visualization of the association between the mammographic image-based phenotypes and the SNP genotypes: (left) The Pearson correlation coefficient map; and (right) corresponding −log10(p) map.

FIG. 15 shows an association analysis between an image-based phenotype (maximum edge gradient, or “MaxEdgeGradient”) and UGT2B SNPs (genotype).

FIG. 16 shows a linear regression of the image-based phenotype MaxEdgeGradient on a genotype SNP position at 69630002 (rs451632) in chromosome 4 resulting in an adjusted p-value of 0.022. Selected image examples from each genotype are shown.

FIG. 17 is a schematic illustration of an exemplary workstation system.

FIG. 18 is a schematic illustration of exemplary hardware of a workstation according to this disclosure.

FIG. 19 illustrates schematically two example scenarios of extracting information from images to create knowledge.

FIG. 20 illustrates a process of estimating a probability of malignancy (PM).

FIG. 21 illustrates an exemplary feature extraction of an image-based risk phenotype.

FIG. 22 illustrates, schematically, an exemplary algorithmic process to generate an image-based array.

FIGS. 23-24 and 26-31 illustrate examples of displaying image-based lesion features or phenotyping after various processes are executed.

FIG. 25 illustrates aspects of quantile normalization and a linear transformation/normalization.

### DETAILED DESCRIPTION

In the drawings, like reference numerals or indicators designate identical or corresponding parts throughout the several views. Further, as used herein, the words “a,” “an” and the like generally carry a meaning of “one or more,” unless stated otherwise. Also, a “patient” refers to a subject (human or non-human) that has undergone, is in the process of, or will be the subject of, treatment, diagnosis, or medical care or service. Further, the color maps or colormaps described herein are shown in the drawings in grayscale. However, various color combinations can be utilized, as will be appreciated in light of the following descriptions. Also, “PM” refers to a probability of malignancy (preferred), or other disease state or condition.

Embodiments described herein relate to methods and systems for an automatic and/or interactive method, system, software, and/or medium for a method and/or workstation for quantitative analysis of data, especially imaging data, which can include, e.g., analysis of full-field digital mammography (FFDM), 2D and 3D ultrasound, CT, tomosynthesis and MRI.

According to one embodiment, a method and a system implementing this method translates image-based features/characteristics of normal states and/or abnormal disease states into a biological array format for use, e.g., in the assessment of disease state (e.g., cancer, cancer subtypes, prognosis, and/or response to therapy) and/or for use in biological discovery. The image-based characteristics can be computer-extracted image features, estimated probabilities of malignancy or other disease state, image-based signatures, and/or pseudo features obtained from dimension reduction techniques. A method and/or workstation can be used to determine and/or employ/incorporate lesion-based analysis, voxel-based analysis, and/or both in the assessment of disease state (e.g., cancer, cancer subtypes, prognosis, and/or response to therapy), and/or both that also may utilize varying the disease state prevalence or prognostic state prevalence within the training or clinical case set. An output can be subjected to a normalization and related to some color map, such as a two-color may with a white or grayish color at the boundary between the two disease types. Such a normalization can include a quantile normalization to avoid outlier effects. An output from such an analyses can be used as an image-based “gene test” where the image-extracted features serve as phenotypes of the gene expression, and can be obtained from, e.g., radiological, histological tissue, molecular, and/or cellular imaging.

In a further embodiment, a method and a system implementing this method can use prevalence transformations to modify the conversion from, e.g., feature, pseudo-feature, or computer estimated probability, to the color map. The color map can be initially determined with a 50:50 disease:non-disease prevalence and then converted for either datasets without the 50:50 prevalence and/or for datasets which include subcategorization of one of more of the disease or non-disease states. In another embodiment, a method and a system implementing this method translates image-based features/characteristics of normal states and/or abnormal disease states into a biological array format for use, e.g., in the assessment of disease state (e.g., cancer, cancer subtypes, prognosis, and/or response to therapy) and/or for use in biological discovery can incorporate biological phenotypes and gene expression data as well as clinical data. According to yet another embodiment, a method and a system implementing this method can include the features, estimated probabilities and/or dimension reduction of characteristics (features) of the lesion (tumor) to indicate where an unknown case(s) is characterized relative to (similar to) the others within the population as indicated on the image-based array.

In one aspect, the overall method includes an initial acquisition of a set of known medical images that comprise a database, and presentation of the images in digital format. The lesion location in terms of estimated center is input from either a human or computer. An exemplary method and system that employs a computer system, such as a workstation, for computer assisted interpretation of medical images includes: access to a database of known biomedical images with known/confirmed diagnoses of normal or pathological state (e.g., malignant vs. benign, invasiveness of the cancers, presence of positive lymph nodes, tumor grade, response to therapy), computer-extraction of features of lesions within the known database, an optional input method for an unknown case, and output including, e.g., presentation of “similar” cases and/or the computer-estimated features and/or likelihood of pathological state and/or color maps corresponding to the feature analysis overlaid on the lesion and/or plots showing the unknown lesion relative to known (labeled) and/or unlabeled cases. A system can implement this method to translate such image-based features/characteristics of normal states and/or abnormal disease states into a biological array format for use, e.g., in the assessment of disease state (e.g., cancer, cancer subtypes, prognosis, and/or response to therapy) and/or for use in biological discovery.

As noted above, gene expression arrays can be used to indicate biological phenotypes/biomarkers, showing, e.g., signatures of expression of a signature with non-expressors. In some aspects discussed herein, image-based phenotypes are incorporated into image-based arrays for biological discovery and/or medical decision making. An output from such an analysis can be used as an image-based “gene test” where the image-extracted features serve as phenotypes of the gene expression, and can be obtained from, e.g., radiological, histological tissue, molecular, and/or cellular imaging.

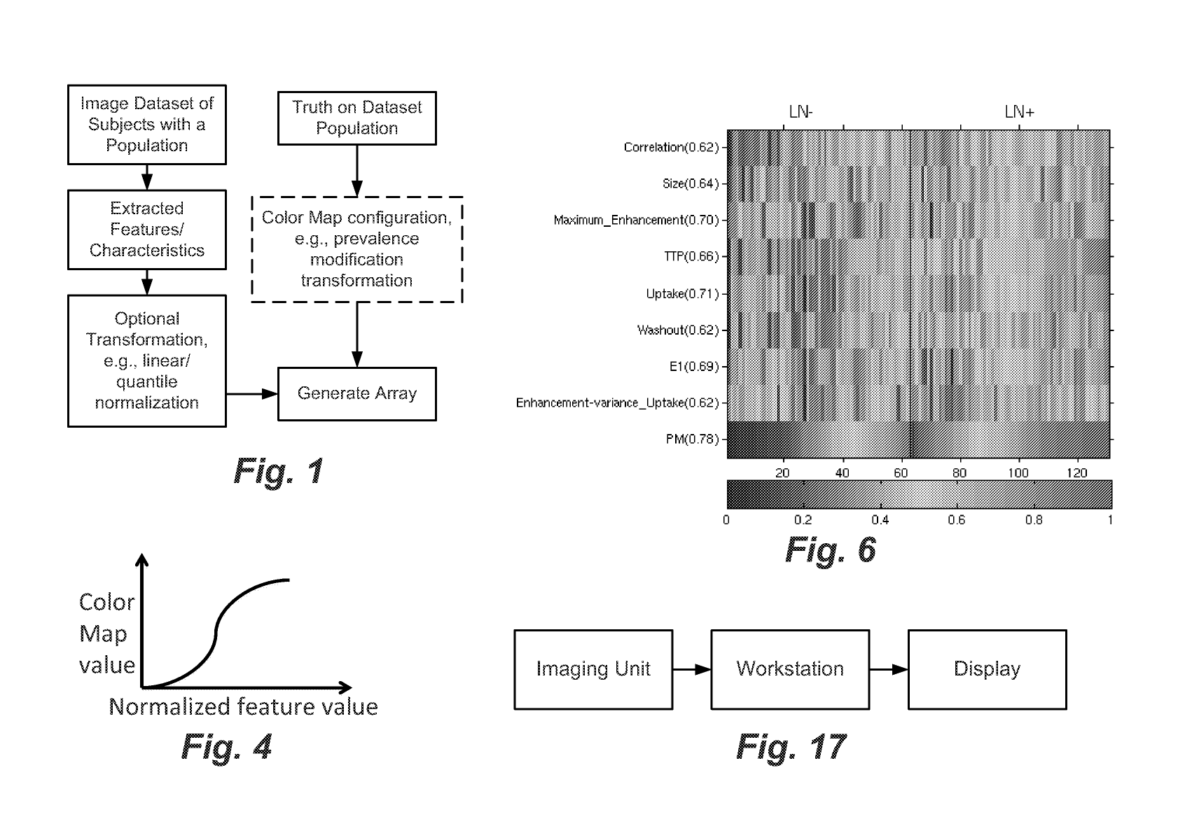

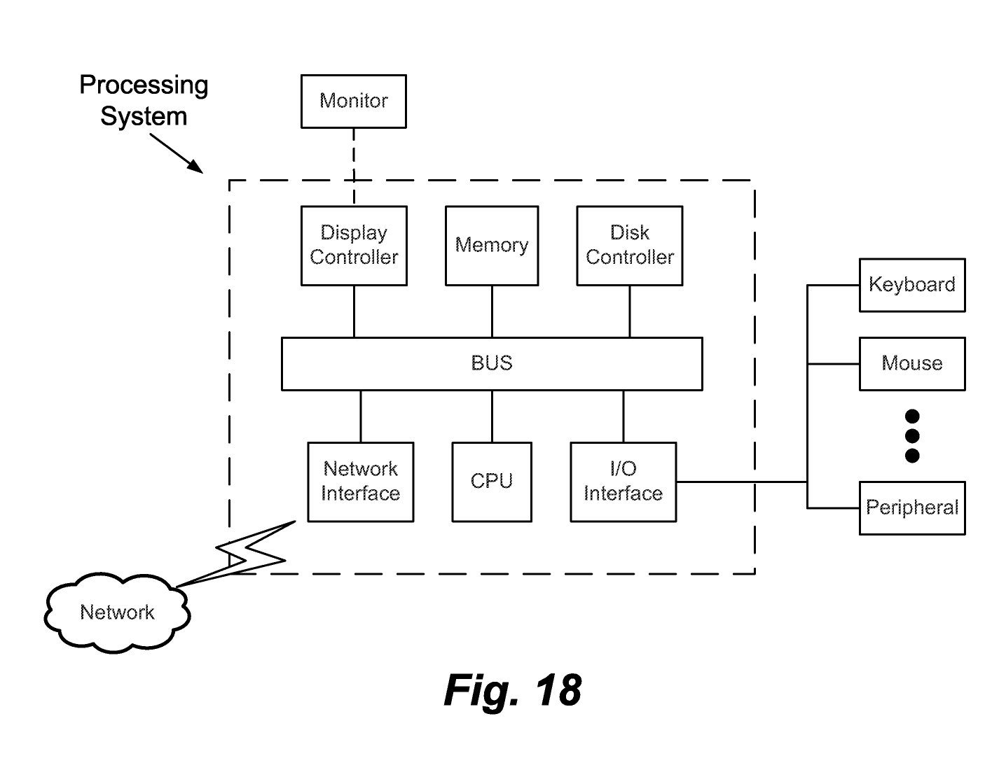

As summarized in FIGS. 1-6, this approach and workstation technique includes methods for incorporating the characterization of tumors or normal aspects from the calculation of image-based biomarkers (image-based phenotypes), e.g., for normality description, breast cancer detection, diagnosis, prognosis, risk assessment, and response to therapy, into an image-based array showing the characteristics over a population, allowing for relating to biological phenotype/genotype array data, aiding in medical decision making, and/or using in biological association studies and discovery. Hardware for such a workstation is shown in FIGS. 17-18, discussed later in further detail. A binary classification example with color map going from red to white to green can be provided (although shown in grayscale herein). For a 50:50 database of malignant:benign, the white is in the middle. Prevalence transformation allows for non 50:50 prevalence in the dataset.

A method for classification of mass lesions can include: (1) manual, semi-automatic, or automatic segmentation of lesions, (2) feature-extraction including aspects of lesion size, morphology, texture, and kinetics, (3) dimension-reduction of lesion features, (4) classification in terms of disease state, e.g., diagnosis, prognosis, response to therapy, (5) determination and display of similar cases, and (6) display of analyses based on lesion or lesion pixel and/or voxel values. See US 2012/0189176. The extraction of relevant lesion characteristics (such as textural, morphological, and/or kinetic features) with which to describe the lesion, and the use of combinations of these characteristics in several classification tasks are performed using artificial intelligence. The output can be given in terms of a numerical value of the lesion characteristic or probability of disease state, prognosis and/or response to therapy.

A method can translate image-based features/characteristics of normal states and/or abnormal disease states into a biological array format for use, e.g., in the assessment of disease state (e.g., cancer, cancer subtypes, prognosis, and/or response to therapy) or for use in biological discovery. The image-based characteristics, such as from radiological, histological tissue, molecular, and/or cellular imaging, can be computer-extracted image features, estimated probabilities of malignancy or other disease state, image-based signatures, and/or pseudo features obtained from dimension reduction techniques. Output from such analysis can be used as an image-based “gene test” where the image-extracted features serve as phenotypes of the gene expression, and can be obtained from, e.g., radiological, histological tissue, molecular, and/or cellular imaging.

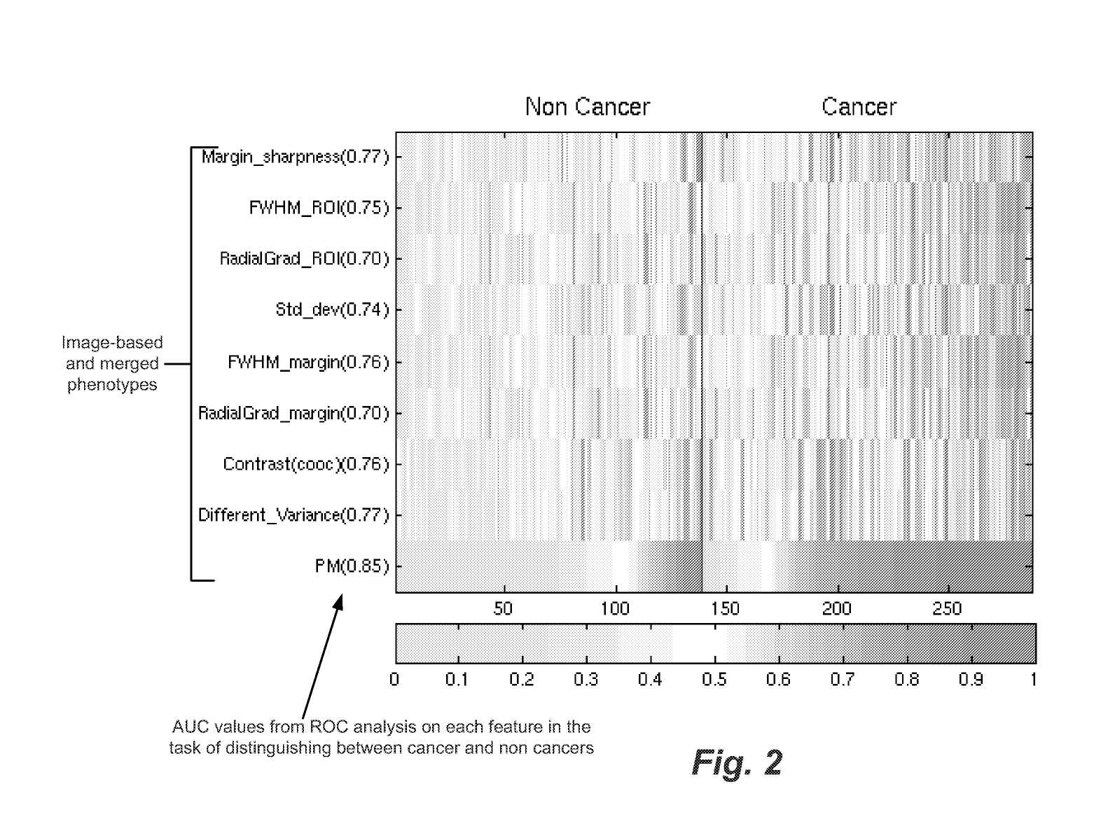

FIG. 1 illustrates an algorithmic process, by way of a flowchart, for incorporating image-based array analysis into computer interpretation of medical images. The example shown is for generating a diagnostic marker array for cancerous and non-cancerous cases. An exemplary array is shown in FIG. 2, where each row is an image-based phenotype/biomarker. Listed therein is the corresponding AUC value from ROC analysis on the single feature. The color map (or colormap) is displayed beneath the image-based phenotype/biomarker array. Output from such analysis can be used as an image-based “gene test” where the image-extracted features serve as phenotypes of the gene expression, and can be obtained from, e.g., radiological, histological tissue, molecular, and/or cellular imaging. The colormap used in FIG. 2 is a green to white to red colormap shown in grayscale, where a scale is: white is set at 0.5, red is set at 1.0 and green is set at 0.0. This scale can be modified so that other colors (or a grayscale) are used. Further, white can be set at a value other than 0.5. In one non-limiting example, 8-bit color can be used to transition from green to white to red in a linear relationship. However, a non-linear relationship can be utilized in another example.

A method can present, elucidate, display image-based findings of normal and disease states to users such as radiologists, oncologists, surgeons, and/or biological researchers, for use in population studies is provided. The methods of presentation can include ranking the patients by disease state while indicating the image-based phenotypes, and other methods to indicate similar image-based phenotypes/signatures. A method to simultaneously view image-based phenotypes and other gene expression/phenotypes and/or genomic data is provided. If the analysis includes the dimension reduction of characteristics (features) of the lesion (tumor), the structure of the lesion types across a population can be given.

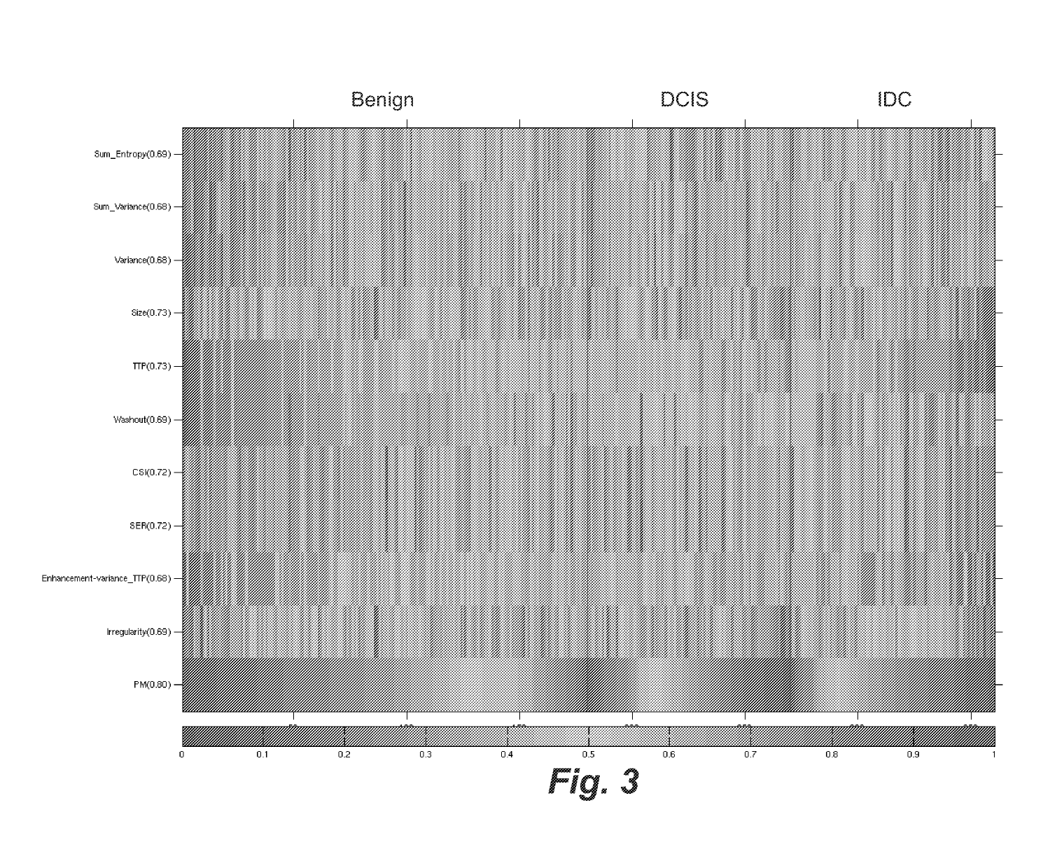

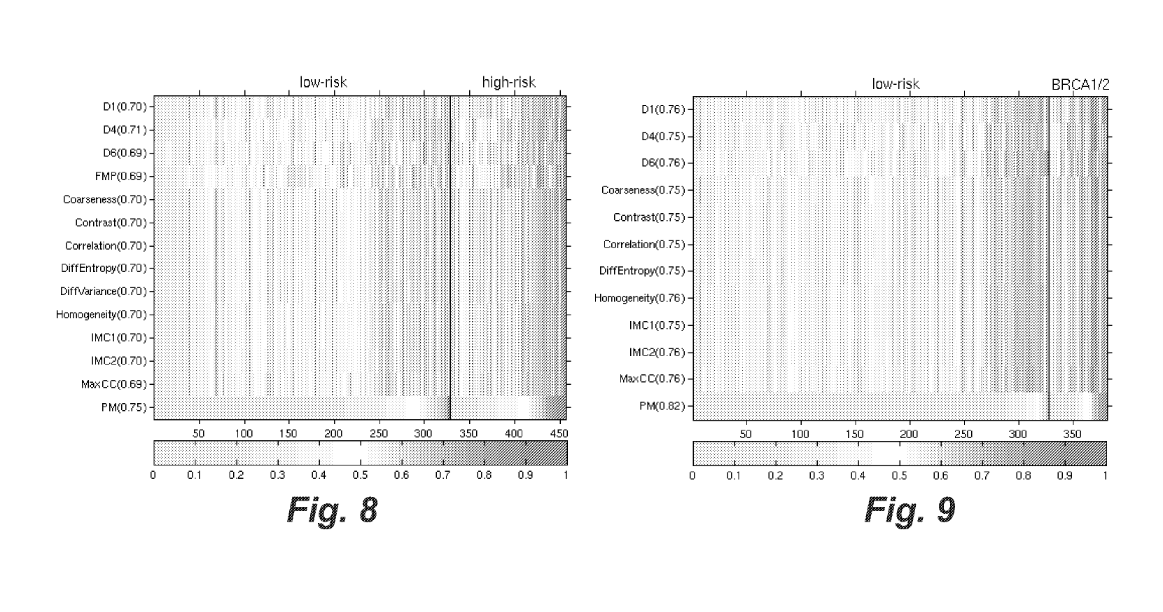

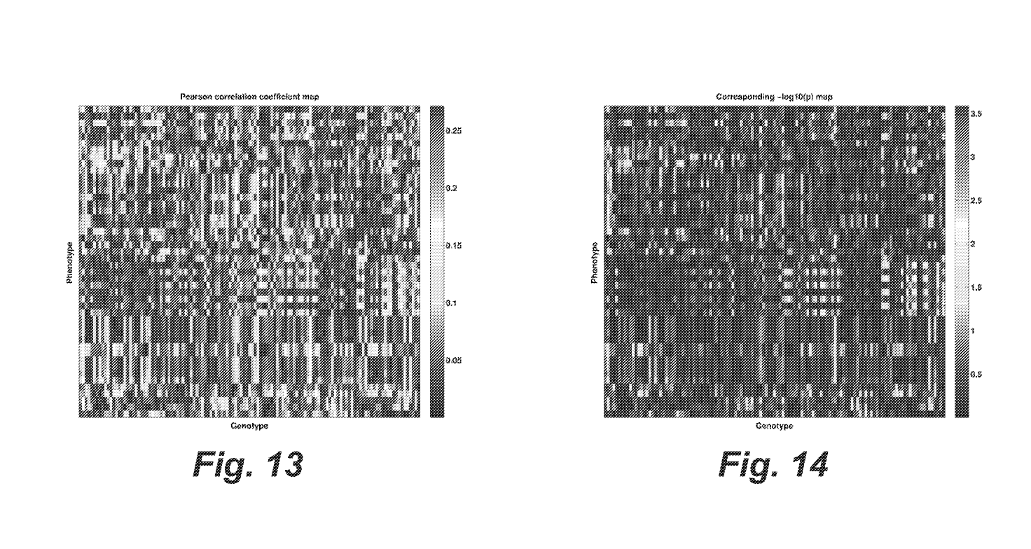

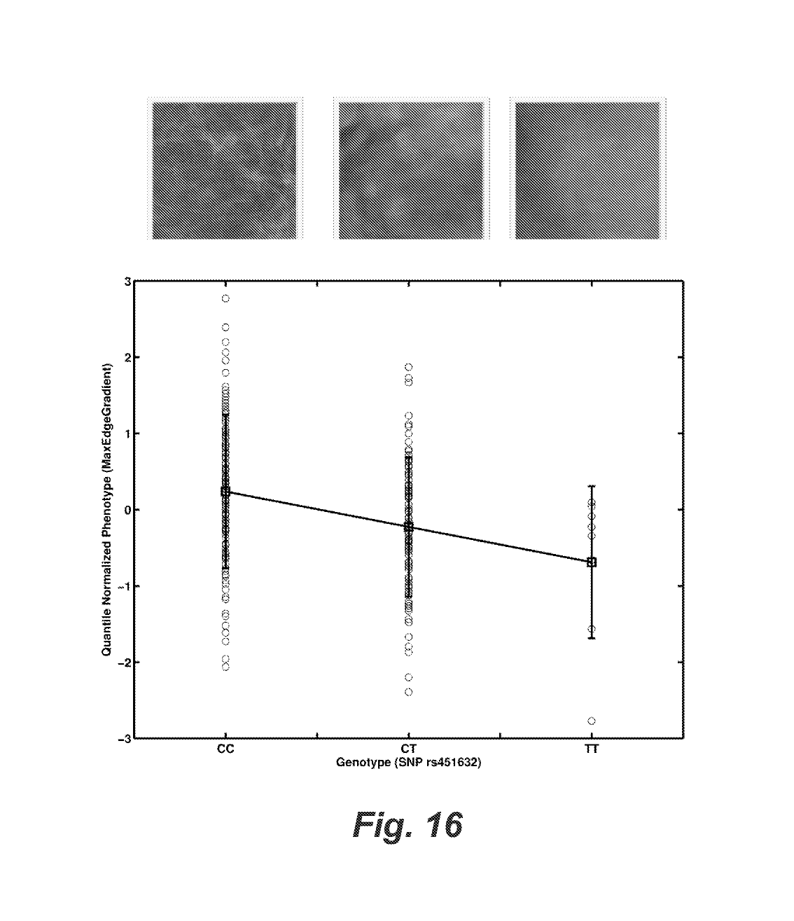

FIG. 3 illustrates another exemplary array that is generated by way of an algorithmic process for incorporating image-based array analysis for biological discovery. The example shown is for cancerous—DCIS and IDC—and benign cases. In this example, output from the analysis can be used in association studies with biological phenotypes/genotype data as demonstrated in FIGS. 13-14, which relates image-based risk phenotypes to SNPs from the UG2TB gene. Shown in FIGS. 13-14 is a visualization of the association between the mammographic image-based phenotypes (which are shown in the risk arrays in FIGS. 8-10) and the SNP genotypes indicating both (a) the Pearson correlation coefficient map and (b) the corresponding −log10(p) map. FIG. 15 shows further association analysis between an image-based phenotype (MaxEdgeGradient) and UGT2B SNPs (genotype). The x-axis gives SNP positions at chromosome 4, and the y-axis is the −log10(p) from an additive model association analysis. FIG. 16 shows a linear regression of the image-based phenotype MaxEdgeGradient on a genotype SNP position at 69630002 (rs451632) in chromosome 4 resulting in an adjusted p-value of 0.022. Selected image examples from each genotype are shown.

Prevalence transformations can be used for the color map, as shown in FIG. 1. Also, ranking of patient cases in the array presentation is utilized. FIG. 4 illustrates a relationship between color map value and normalized feature value, which can be utilized in the color map. Due to datasets and populations having different prevalence for normal characteristics or disease states, a calculation and/or a display of such image-based array information to allow for varying of a disease state prevalence or a prognostic state prevalence is provided.

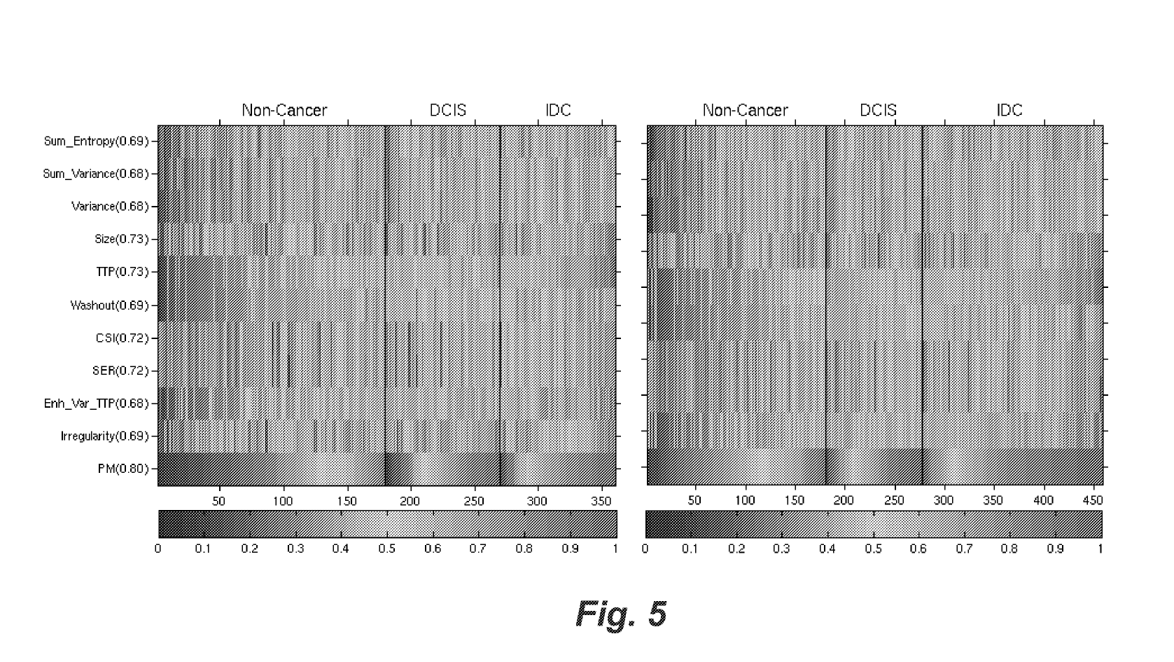

FIG. 5 illustrates an original image-based array (left) from which the 50:50 color map transformation was obtained, and an extended image-based array (right) in which the color map transformation was modified given the new disease-state prevalence in the enlarged dataset. In particular, the left array shows an original dataset with 50:50, cancer: non-cancer, and the right array shows a different prevalence (not 50:50, cancer: non-cancer), in which it is modified so that the grayish white region of the color map continues to refer to a center. The example is for a prognostic phenotype/biomarker. Another option in the display of the image-based phenotype color map is that the output can be modified relative to the disease prevalence under different clinical or general population scenarios. The analyses can include a single modality, multiple modalities, multiple scales (e.g., human MRI and/or histopathological imaging), and/or multiple acquisition types for a single modality. FIG. 6 shows an original image-based array from which the 50:50 color map transformation was obtained in which half the patients had positive lymph nodes and the other half had negative lymph nodes.

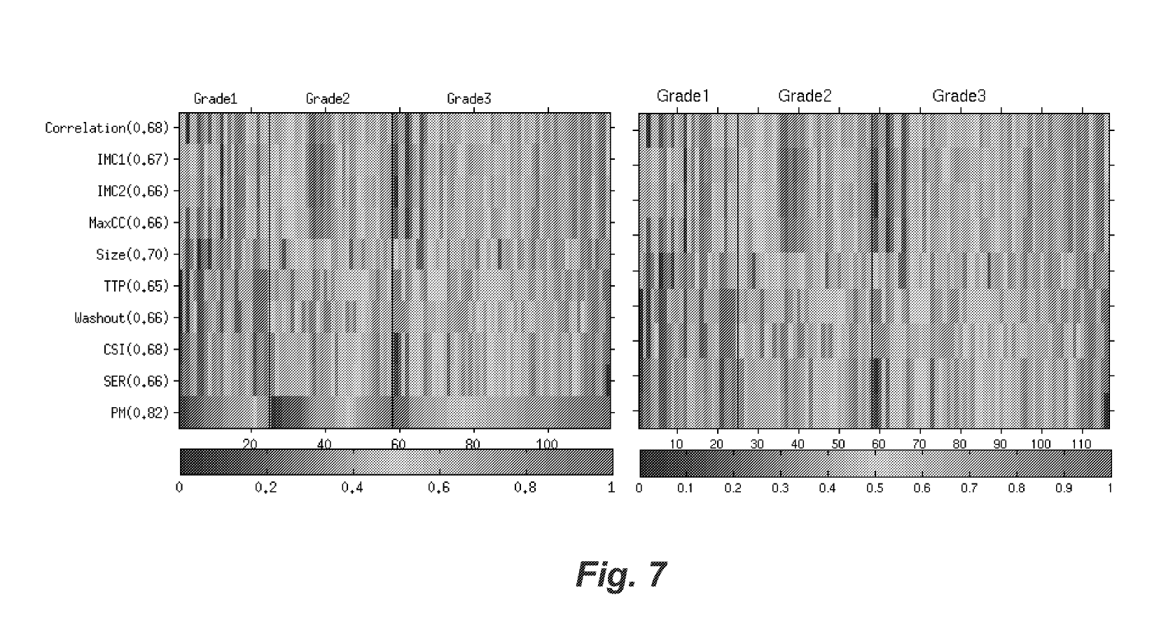

FIG. 7 shows two image-based arrays from which the 50:50 color map transformation was obtained in which half the patients had Grade 3 cancer and the other half had either Grade 1 or Grade 2 cancer. Note that the population is subcategorized by the three grades while keeping the color map to the 50:50. Note that the patients are ranked based on the computer-determined probability that the lesion is a Grade 3 as shown by the lower row in the left array.

FIG. 8 shows an image-based array to demonstrate population of women—some known to be at high risk of breast cancer and some at low risk. Note that there is not a 50:50 prevalence.

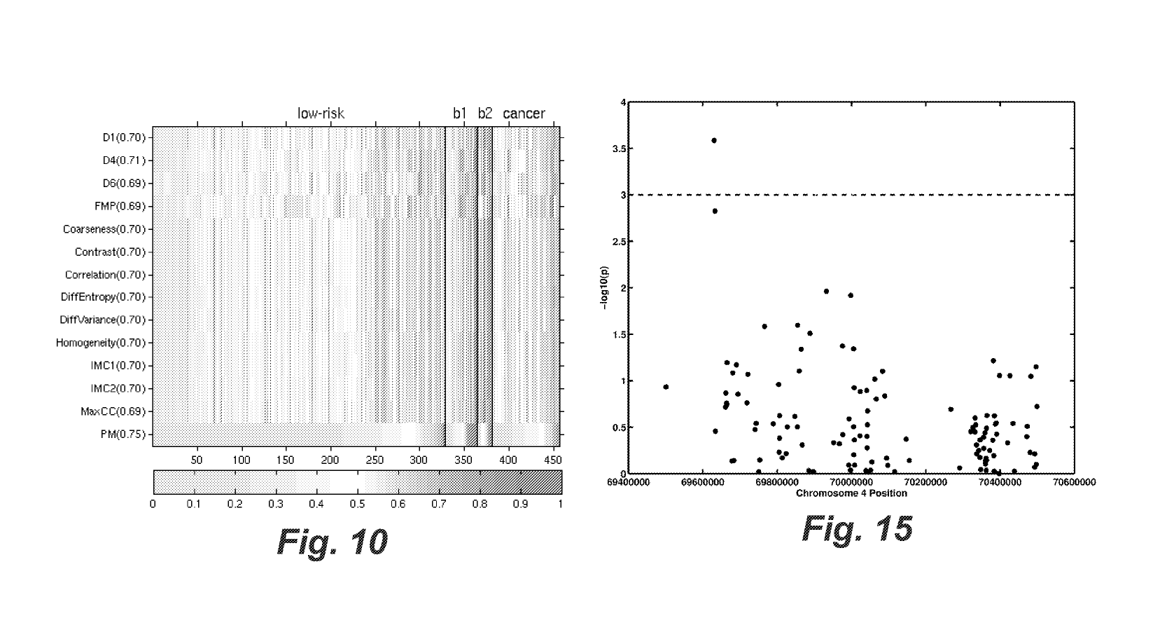

A prevalence transformation was conducted to maintain a middle “white.” FIG. 9 shows the use of image-based arrays to demonstrate population of women—some known to be BRCA1 or BRCA2 gene mutation carriers and thus at high risk of breast cancer and some at low risk. Note that there is not a 50:50 prevalence. FIG. 10 shows the use of image-based arrays to demonstrate population of women—some known to be at high risk of breast cancer and some at low risk. Note that there is not a 50:50 prevalence. Note also that the high-risk group is subcategorized by BRCA1, BRCA2, or unilateral cancer

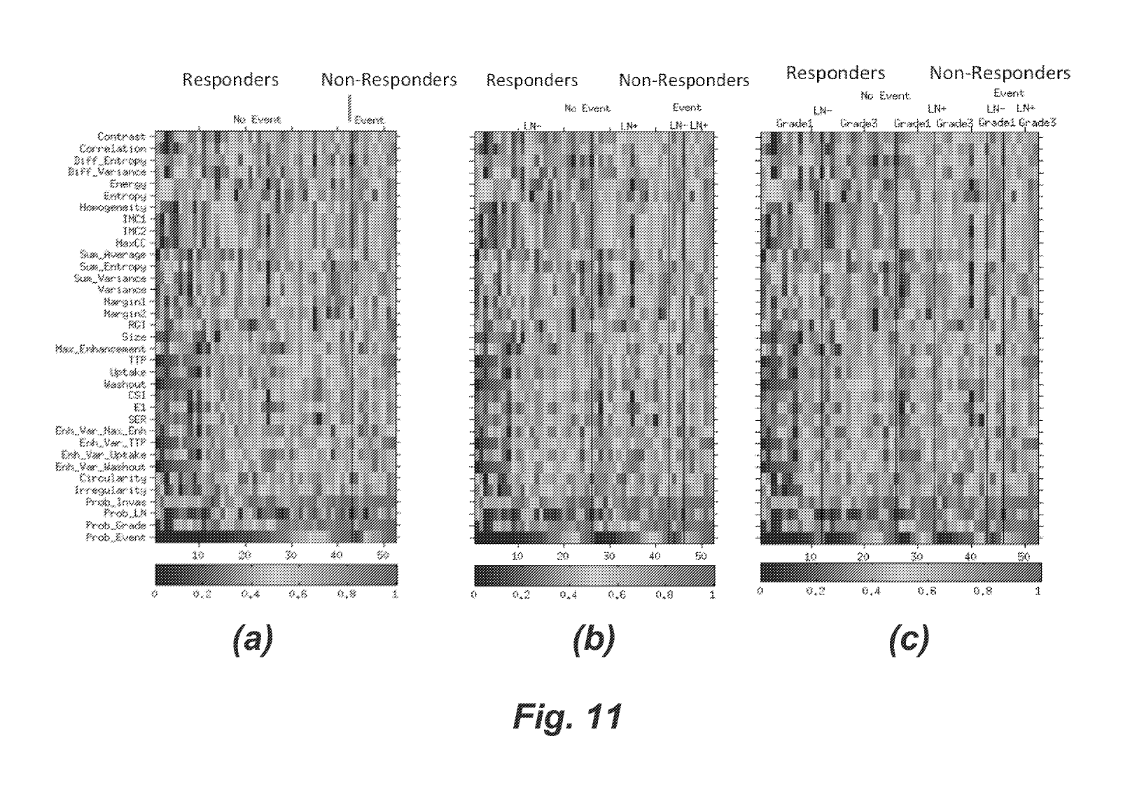

FIG. 11 (a, b, c) shows image-based arrays from which the 50:50 color map transformation was obtained to demonstrate a population of breast cancer patients—some who responded to therapy (no event) and some who did not respond (event) (i.e., responders and non-responders), for event vs. no event, for added subcategory of lymph node status, and for added subcategory of tumor grade. Note that here the responder can be relative to survival, lack of metastatic disease, or other. It is apparent that such arrays can be useful for discovery on relating the image-based phenotypes/biomarkers to histopathlogy (and genomics). In FIG. 11(a), an image-based array is illustrated to demonstrate a population of breast cancer patients—some who responded to therapy and had no future event and some who did not respond and had an “event” such as reoccurrence. In FIG. 11(b), an image-based array is illustrated to demonstrate a population of breast cancer patients—some who responded to therapy and had no future event and some who did not respond and had an “event” such as reoccurrence. Here the subcategory for lymph node positive and lymph node negative is also shown. Note that the “no event” with negative lymph nodes have the most blue. In FIG. 11(c), an image-based array is illustrated to demonstrate a population of breast cancer patients—some who responded to therapy and had no future event and some who did not respond and had an “event” such as reoccurrence. Here the subcategory for lymph node positive and lymph node negative [LN+ & LN−] and the subcategory for tumor grade [Grade3 & Grade 1] are also shown. Note that the “no event” with negative lymph nodes AND tumor Grade 1 have the most blue.

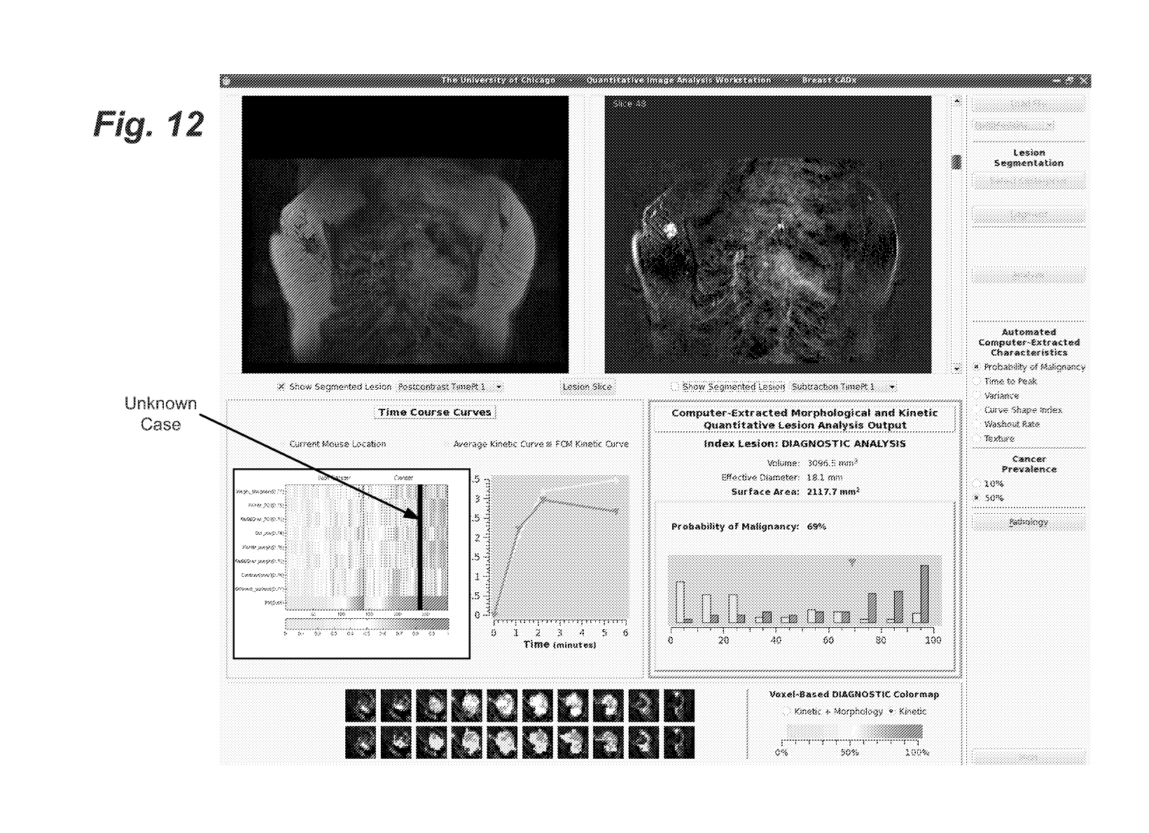

FIG. 12 shows an example of a workstation display for a malignant lesion—showing the segmented lesion on DCE-MRI, the average kinetic and most enhancing kinetic curves, the voxel-based diagnostic colormap, and the lesion's volumetrics of volume, effective diameter, and surface area. Techniques for displaying these images are described in, e.g., U.S. Ser. No. 13/305,495 (US 2012/0189176), incorporated by reference herein in its entirety. An image-based biomarker array is provided in a lower left portion in which a black line indicates the unknown case (a patient with an unknown or yet-to-be diagnosed condition)—showing that patient's tumor signature ranked within the image-based array. In the image-based biomarker array in the lower left portion, a black line indicates the unknown case—showing a patient's tumor signature ranked within the image-based array. The black line is merely an exemplary implementation. Further, although referred to as a “black” line, the line can be another color, such as a color that contrasts the other colors used in the array. The black line can also be a highlight (such as a partially transparent color highlight), which allows for the feature values of the unknown case to still be at least partially discernible/viewable through the highlight. Also, the highlight can be a border or bracket that clearly indicates the unknown case amongst the other cases. A fine line can also be utilized, which itself does not portray any particular feature values, but is placed directly to the left and/or right of the feature values of the unknown case, so as to visually single out the unknown case from amongst the other cases. Further, instead of extending a full length (top to bottom) of the image array, the black line or highlight can extend only through one of the feature values, such as a selected feature value (preferably PM). A user, can then selected, via a mouse-cursor input, e.g., another feature to move the black line or highlight to the selected feature, so that a feature value can be clearly visible.

As in the non-limiting example shown in FIG. 12, two groups or categories of cases are shown—non-cancer and cancer. A processing system can determine which of these groups to insert the unknown case into (i.e. a location indicating where to insert pixels corresponding to a “new” patient's feature values), or a user can select which of these groups to insert the unknown case into. For example, one of the groups (a “location”) can be identified/selected/determined by a two-class classifier that is executed by the processing system. The groups can be grouped into one group for a binary decision in the two-class classifier. In an N-class classifier, the location can be determined in N-class space and projected to a two-class order. A “best-fit” model can also be used to determine a location which best fits the feature values of the unknown case. Further, a toggle, switch or button can be provided that allows a user to toggle the location of the feature values and pixels of the unknown case from being present in one group, to being present in another group, to being removed altogether.

The above-discussed drawing figures show the workings of the new image-based array analysis and workstation for image-based biomarkers (image-based phenotypes). A normal state or abnormal state can be characterized in terms of individual image features (e.g., size/volumetrics/surface area, morphological, kinetics), probability of malignancy, types of prognostic indicators (e.g., invasiveness, lymph node involvement, tumor grade, HER2neu, etc., response to therapy), and dimension reduction pseudo features, and array color maps, obtained with various normalizations and prevalence transformations.

FIGS. 13-14 demonstrate a visualization of the association between the mammographic image-based phenotypes and the SNP genotypes: (a) The Pearson correlation coefficient map; and (b) corresponding −log10(p) map. In FIGS. 13-14, a full-color color scale is used, but shown in grayscale, in the color map shown to the right of the maps. The scale transitions, from top to bottom, from deep red to red to orange to yellow to green to aquamarine to blue to dark blue. As discussed above, however, a different color scale can be utilized in another example.

FIG. 15 shows an association analysis between an image-based phenotype (MaxEdgeGradient) and UGT2B SNPs (genotype). The x-axis gives SNP positions at chromosome 4, and the y-axis is the −log10(p) from an additive model association analysis.

FIG. 16 shows a linear regression of the image-based phenotype MaxEdgeGradient on a genotype SNP position at 69630002 (rs451632) in chromosome 4 resulting in an adjusted p-value of 0.022. Selected image examples from each genotype are shown.

FIG. 17 illustrates a schematic diagram for a system for incorporating the new method/interface/workstation into a medical task of diagnosis, prognosis, or response to therapy, or in biological discovery and association studies, such as displaying images, histograms, etc. as in FIG. 13. Initially, a means or system for acquiring the image data or patient information data is provided (imaging unit). This can be a mammographic unit, e.g., which can be connected to the workstation via a network, through a network connection, or as a peripheral through a data terminal connection. The medical image/data information is then analyzed by a computer to yield a probability that a particular disease is present (e.g., breast cancer) by a computerized analysis circuit (workstation). An output device (display) is used as an option to display the computer-determined probability of disease state. Volumetrics of the lesion can also be displayed via the output device. It should be appreciated the imaging unit can also be embodied as a database of stored images or medical data, which is processed in accordance with the above-presented algorithms.

Accordingly, embodiments according to this disclosure include approaches and systems that create image-based arrays from feature values (e.g., characteristic; image-based biomarker; image-based phenotype), dimension reduced features (pseudo feature), or estimates of a probability of disease state (which can be a characteristic of normal, a probability of malignancy, cancer subtypes, risk, prognostic state, and/or response to treatment), usually determined by training a classifier on datasets. Output from such analysis can be used as an image-based “gene test” where the image-extracted features serve as phenotypes of the gene expression, and can be obtained from, e.g., radiological, histological tissue, molecular, and/or cellular imaging.

It should be noted that although the method is presented on breast image data sets, the approach, system, and/or workstation can be implemented on a variety of medical images from a variety of imaging modalities of any in vivo or ex vivo portion of a subject (such as chest radiography, magnetic resonance imaging, histopathological imaging, etc.) in which a computerized analysis of image or lesion features is performed with respect to some normal state or disease state.

Additionally, embodiments according to this disclosure may be implemented using a conventional general purpose computer or micro-processor programmed according to the teachings of this disclosure, as will be apparent to those skilled in the computer art. Appropriate software can be readily prepared based on the teachings herein, as should be apparent to those skilled in the software art. In particular, the workstation described herein can be embodied as a processing system according to FIG. 18, and can include a housing that may house a motherboard that contains a CPU, memory (e.g., DRAM, ROM, EPROM, EEPROM, SRAM, SDRAM, and Flash RAM), and other optional special purpose logic devices (e.g., ASICS) or configurable logic devices (e.g., GAL and reprogrammable FPGA). The computer also includes plural input devices, (e.g., keyboard and mouse), and a display controller for controlling output to a monitor. A network interface is also provided for communication via a network, such as the Internet or an intranet. In such aspects, communication between an imaging device (or an image database) can be performed via the network, or via an input/output interface (such as a USB or other data transfer connection).

Additionally, the computer may include a floppy disk drive; other removable media devices (e.g. compact disc, tape, and removable magneto-optical media); and a hard disk or other fixed high density media drives, connected using an appropriate device bus (e.g., a SCSI bus, an Enhanced IDE bus, or an Ultra DMA bus). The computer may also include a compact disc reader, a compact disc reader/writer unit, or a compact disc jukebox, which may be connected to the same device bus or to another device bus. These components can be controlled by a disk controller.

Examples of computer readable media associated with this disclosure include compact discs, hard disks, floppy disks, tape, magneto-optical disks, PROMs (e.g., EPROM, EEPROM, Flash EPROM), DRAM, SRAM, SDRAM, etc. Stored on any one or on a combination of these computer readable media, processes and/or algorithms can be executed utilizing software for controlling both the hardware of the computer and for enabling the computer to interact with a human user. Such software may include, but is not limited to, device drivers, operating systems and user applications, such as development tools. Computer program products according to this disclosure include any computer readable medium which stores computer program instructions (e.g., computer code devices) which when executed by a computer causes the computer to perform the methods, processes and/or algorithms of this disclosure. The computer code devices of this disclosure may be any interpretable or executable code mechanism, including but not limited to, scripts, interpreters, dynamic link libraries, Java classes, and complete executable programs. Moreover, parts of the processing of this disclosure may be distributed (e.g., between (1) multiple CPUs or (2) at least one CPU and at least one configurable logic device) for better performance, reliability, and/or cost. For example, an outline or image may be selected on a first computer and sent to a second computer for remote diagnosis, utilizing network connections and the Internet. Aspects of this disclosure may also be implemented by the preparation of application specific integrated circuits or by interconnecting an appropriate network of conventional component circuits, as will be readily apparent to those skilled in the art.

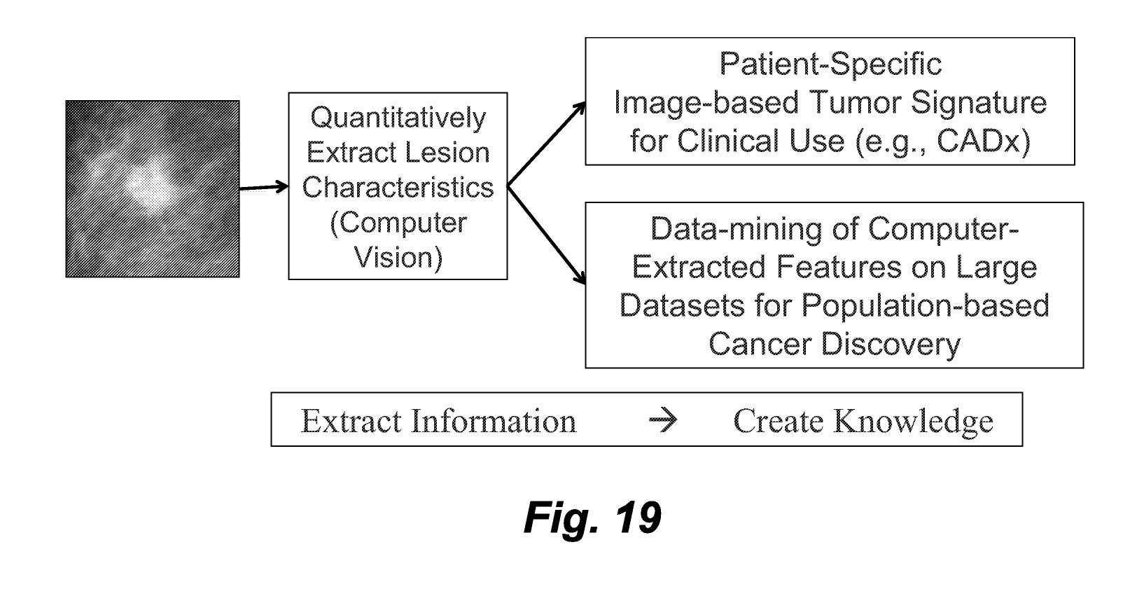

A biomarker refers to a characteristic that is objectively measured and evaluated as an indicator of normal biologic or pathogenic processes or pharmacological response to a therapeutic intervention. An image-based biomarker is a biomarker extracted from biomedical image data. Examples can include various computer-extracted lesion features (image-based phenotypes) used in CAD (computer-aided diagnosis) and in quantitative imaging. Exemplary roles of image-based biomarkers (tumor signature/phenotypes) are in the management of the cancer patient and the understanding of cancers. Two possible scenarios are shown by example in FIG. 19. A purpose is to investigate the use of array plots and analyses in the visualization and assessment of image-based breast cancer tumor signatures.

Datasets and feature extraction examples are shown below in the following table.

| | | Diagnostic/Prognostic | |
|---|---|---|---|
| Clinical Task | Diagnostic Assessment | Assessment | Breast Cancer Risk |
| Modality | Mammography | MRI | Mammography |
| Total Cases | 287 cases | 360 cases | 456 cases |
| Subsets | 148 cancers | 180 cancers (90 IDC, 90 | 128 high risk women |
| | 139 benign lesions | DCIS); 180 non-cancers | 328 low risk women |
| Computer- | Lesion shape, margin | Lesion shape, kinetics, & | Breast percent |
| extracted | sharpness, spiculation, & | heterogeneity | density, & |
| features | texture | | parenchyma texture |
| Signature | Estimate of probability | Estimate of probability of | Estimate of likelihood |
| | of malignancy | malignancy | of being at high risk |
| | | | for future breast |
| | | | cancer |

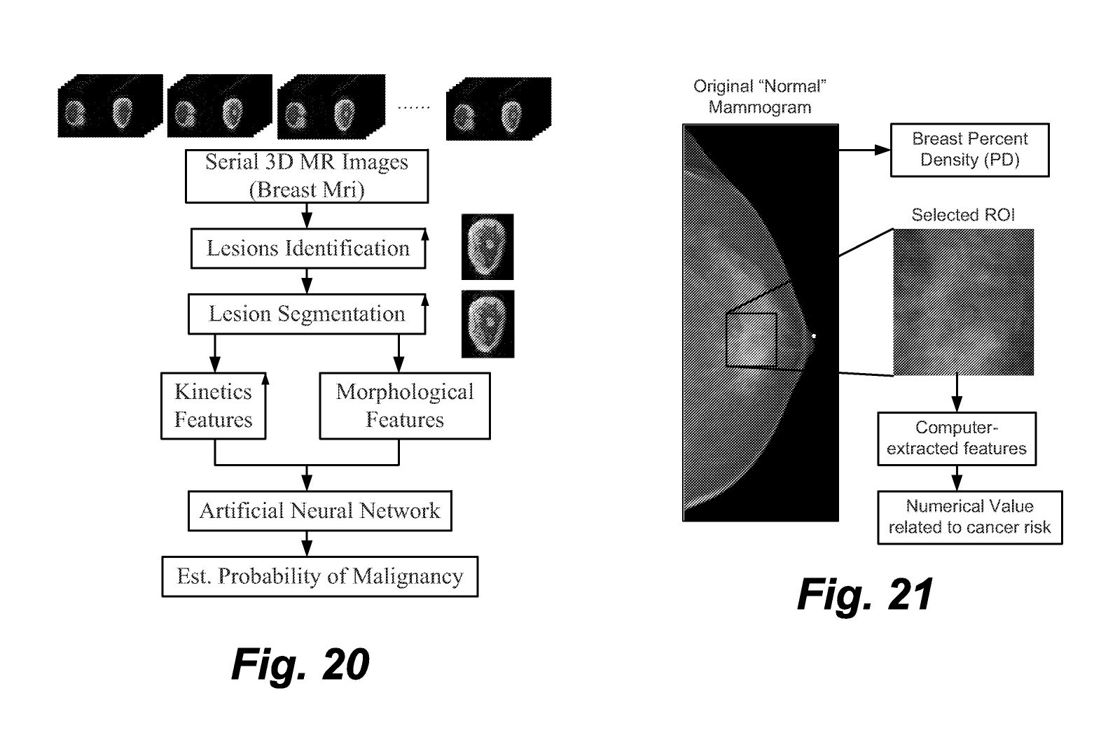

Image segmentation can be performed in a manner consistent with that described in US 2012/0189176, which is incorporated herein by reference. Further, a probability of malignancy can be estimated in accordance with the algorithm shown in FIG. 20.

In the following examples, the features identified in the list to the left of the color map are computer-extracted mammographic lesion characteristics.

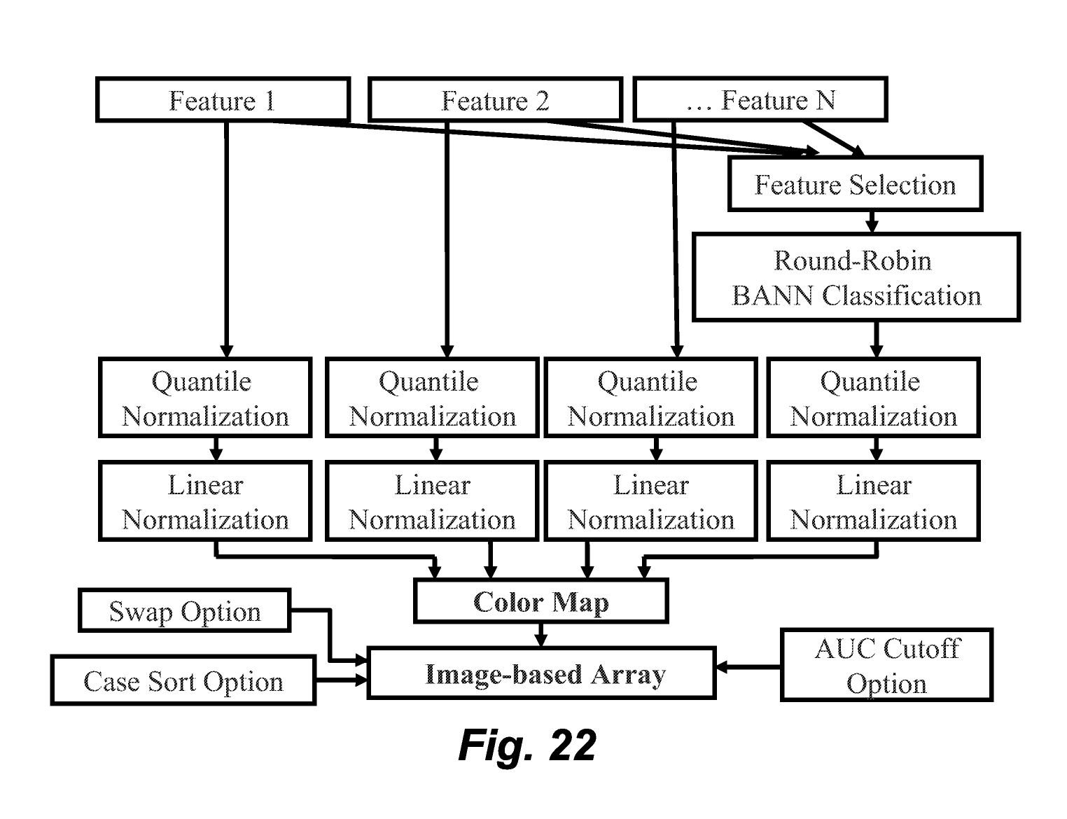

FIG. 21 illustrates an exemplary feature extraction of an image-based risk phenotype, including breast parenchyma density and texture analysis. Here, identification and close follow-up of high risk women can provide an opportunity for patient-specific screening guidelines. Computerized image-based markers can be identified for use in monitoring preventive and therapeutic treatment. In FIG. 21, computer-extracted features characterize denseness and texture of region (RTA) using mathematical descriptors. The selected region of interest (ROI) can be a central region of 256×256 pixels. A numerical value related to risk of breast cancer can be an image-based biomarker. According to the above, calculation and display of image-based arrays from of image-based computer-extracted features and tumor signatures can be performed. Arrays relate the image-based features and/or merged signature across a population of subjects/patients. An exemplary process is shown in FIG. 22. In an example utilizing a three-color gradient map, normalization can be conducted so that each computer-extracted feature has values within the range of 0 to 1. Three colors (e.g., green, white, red) can be chosen, where green: 0, white: 0.5, and red: 1. A depth of color gradient (e.g., 256) can be chosen, and feature values can be matched into the color gradient map (i.e. colormap or color map).

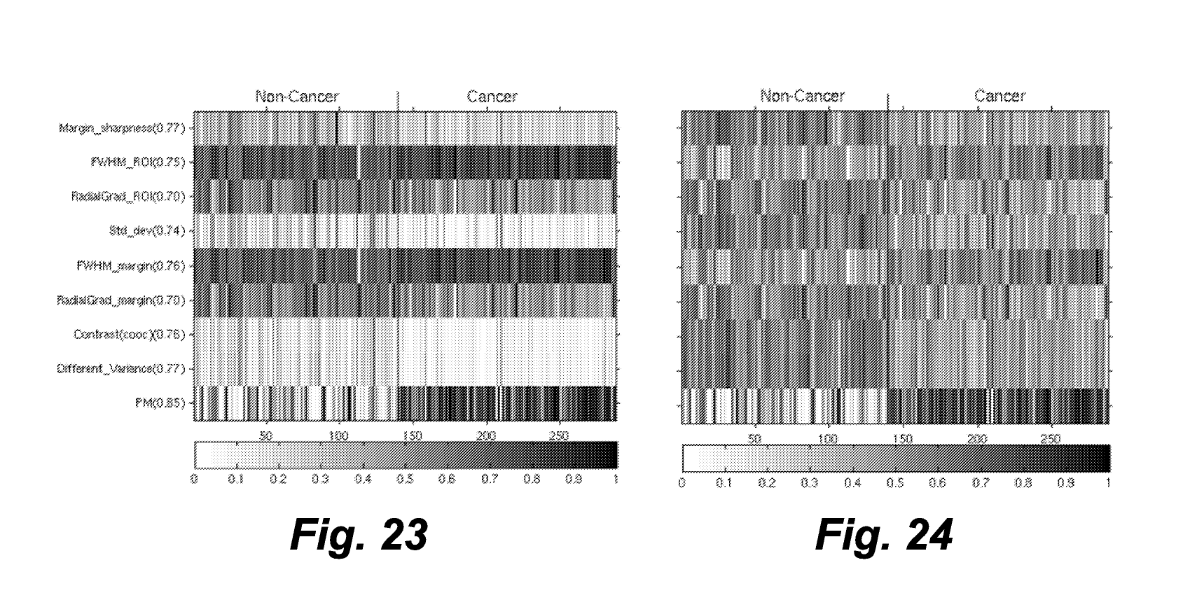

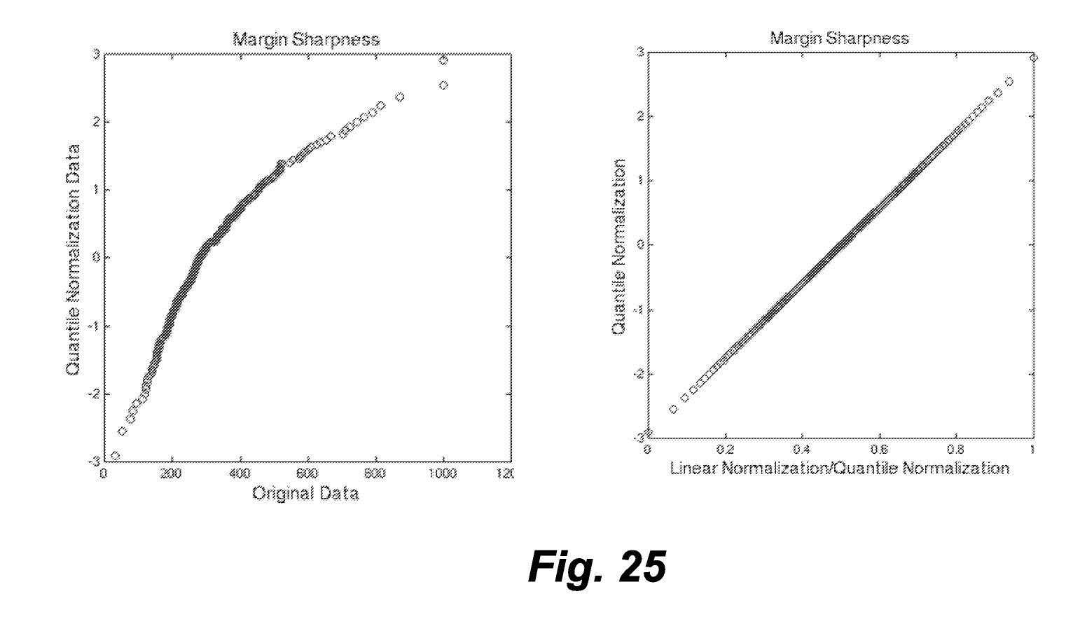

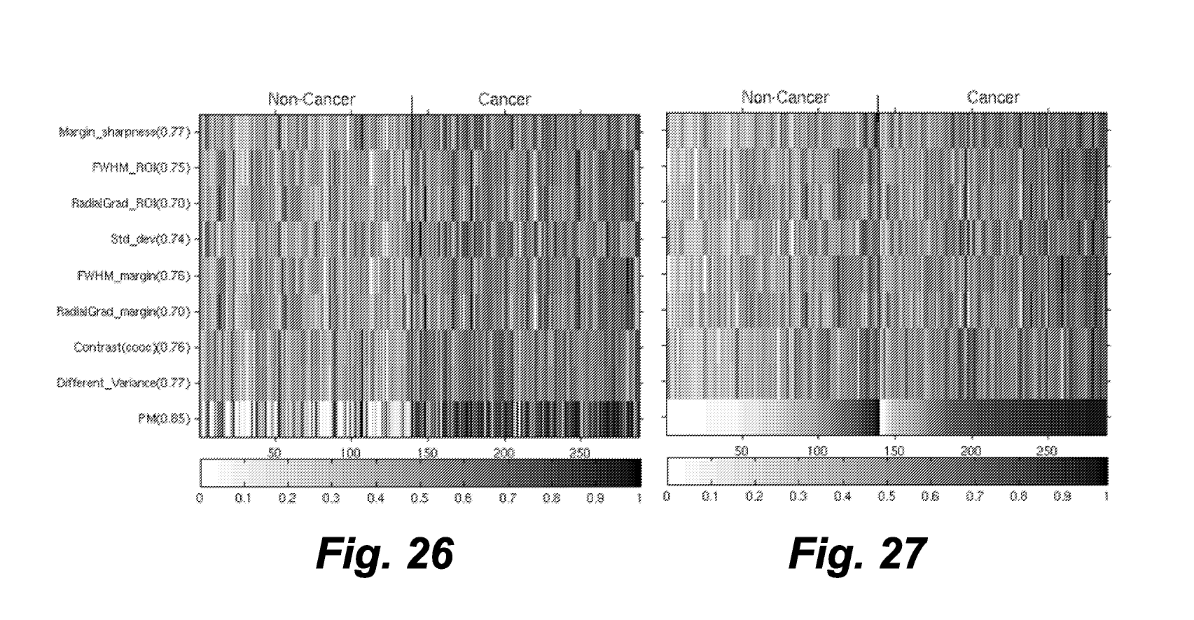

FIG. 23 illustrates an example of image-based lesion features after linear normalization (mapping of image-based feature values to values between 0 and 1) with a grayscale colormap. FIG. 24 illustrates another example of image-based lesion features after quantile normalization and linear transformation of image-based feature values to values between 0 and 1 with a grayscale colormap. FIG. 25 illustrates aspects of quantile normalization and then a linear transformation. FIG. 26 illustrates an example of image-based lesion features after quantile normalization and linear normalization, and then swapping values based on a mean value of each category with a grayscale colormap. FIG. 27 illustrates an example of image-based lesion features after quantile normalization and linear normalization, after swapping, and sorting by PM value with a grayscale colormap. Sorting includes ranking subjects/patients by their PM value (or feature value).

An example of a rapid high-throughput image-based phenotyping yielding a mammographic diagnostic image array can involve an image-based array for non-cancers and cancer subtypes: DCIS, and IDC, individual image-based “phenotypes” ranged in AUC from 0.68 to 0.72, with the merged signature having an AUC of 0.80. Visual distinction between the non-cancers and cancers was highly apparent, and, in addition, the color-coding visually demonstrated the “aggressiveness” of the IDC as compared to the DCIS cases. In the image-based risk array, individual image-based “phenotypes” ranged in AUC from 0.69 to 0.71, with the merged signature having an AUC of 0.75.

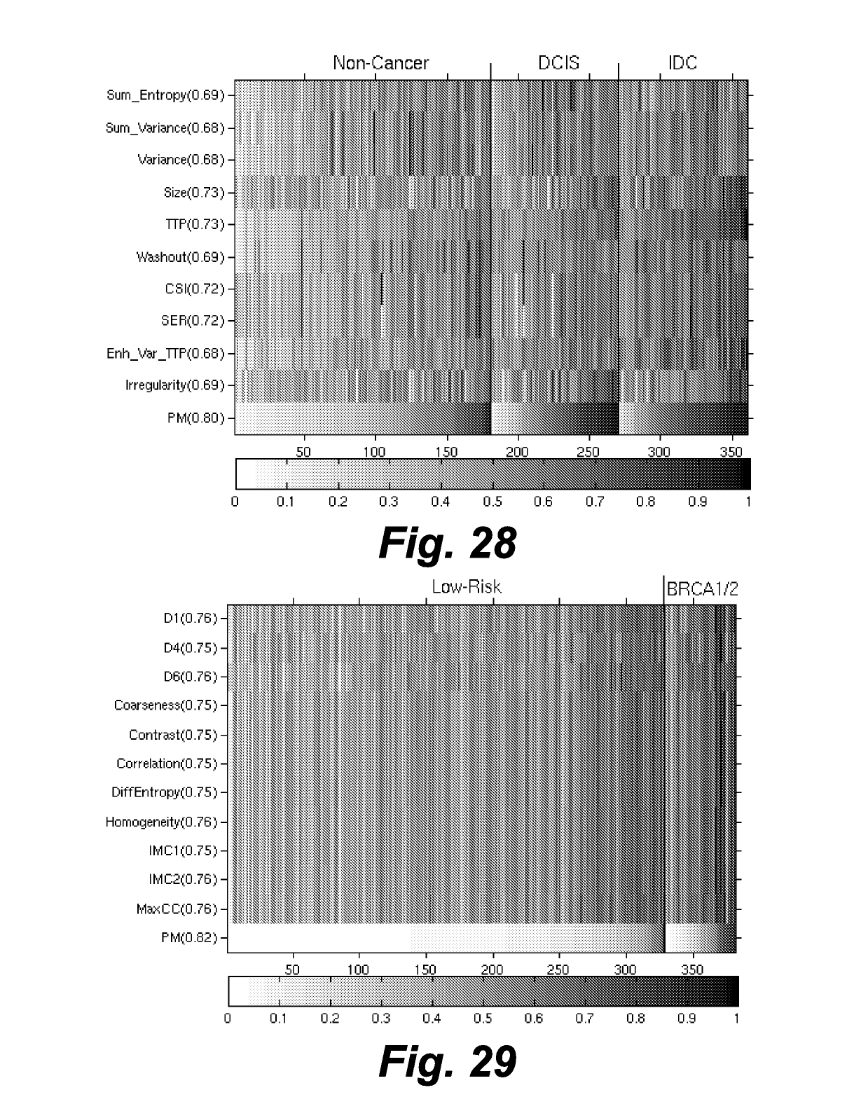

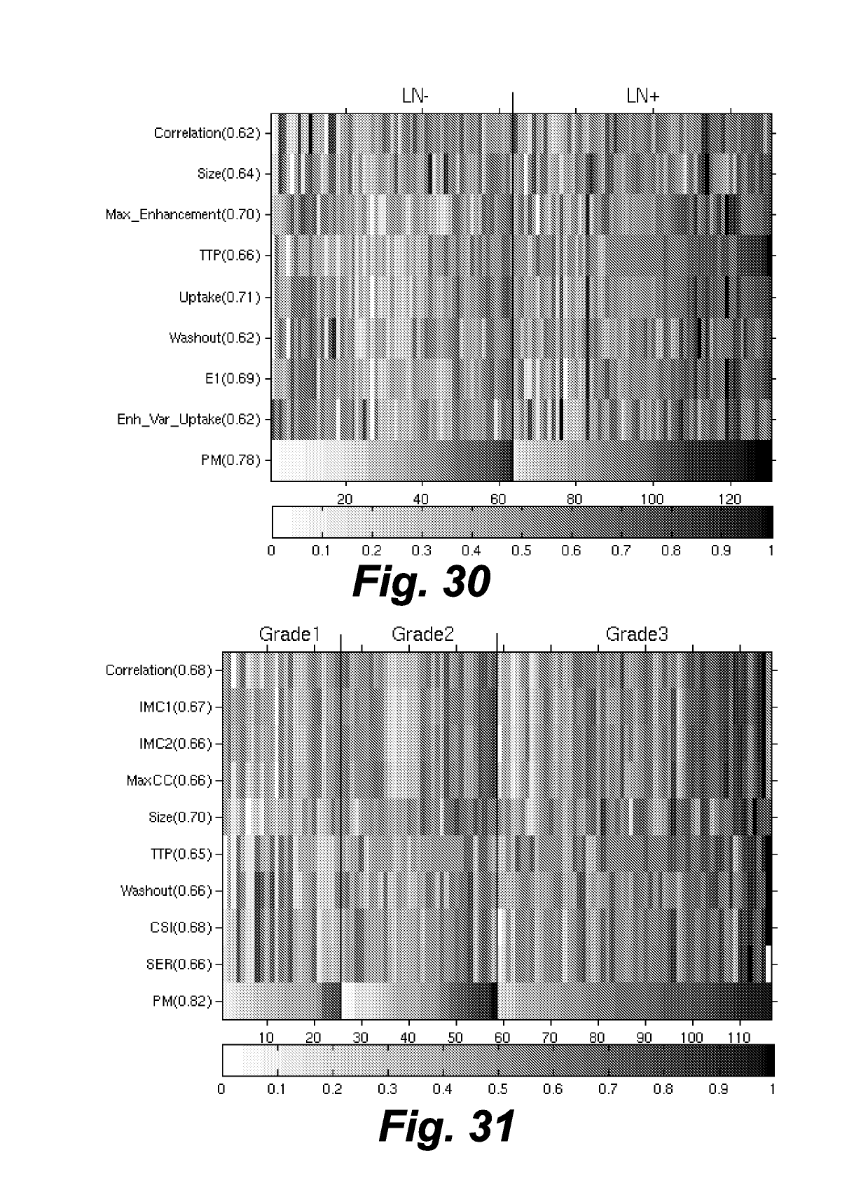

FIG. 28 illustrates an example of rapid high-throughput image-based phenotyping yielding a MRI diagnostic/prognostic image array with a grayscale colormap. FIG. 29 illustrates an example of a rapid high-throughput image-based phenotyping yielding a mammographic cancer risk array with a grayscale colormap. FIG. 30 illustrates an example of a rapid high-throughput image-based phenotyping yielding a MRI prognostic image array with a grayscale colormap (cancer cases: lymph node positive and negative). FIG. 31 illustrates an example of a rapid high-throughput image-based phenotyping yielding a MRI prognostic image array with a grayscale colormap (cancer cases: different grade).

The use of quantile normalization and color scaled maps have yielded a method for the visualization of image-based tumor and parenchyma signatures in order to assess the performance and correlation of potential image-based biomarkers. The array visualization method for image-based tumor signatures is expected to elucidate the relationship between various image-based biomarkers, as well as with clinical and histological biomarkers.

Numerous modifications and variations are possible in light of the above teachings. It is therefore to be understood that within the scope of the appended claims, aspects described herein may be practiced otherwise than as specifically described herein.

1. A workstation, comprising one or more processors configured to:
generate an image array including a plurality of pixels, each of the pixels representing an image-based feature value of a patient obtained from imaging the patient, the image array including first and second dimensions so that pixels corresponding to a specific patient of a plurality of patients extend in the first dimension and pixels corresponding to a specific feature of a plurality of features extend in the second dimension;
group the patients represented in the image array into two or more groups, each of the groups indicating a known condition of the patients, such that patients having a first condition are part of a first group and are in a first portion of the array, and patients having a second condition are part of a second group and are in a second portion of the array; and
organize, separately, each of the groups according to a selected feature of the features, such that the patients of the first group are arranged in an order of values for the selected feature within the first portion, and the patients of the second group are arranged in an order of values for the selected feature within the second portion.

2. The workstation of claim 1, wherein the one or more processors are further configured to obtain values of the features for a new patient having an unknown condition, and insert pixels corresponding to the new patient into the array according to a value of the selected feature for the new patient.

3. The workstation of claim 2, wherein the one or more processors are further configured to highlight the pixels corresponding to the new patient that are inserted into the array relative to other pixels of the array.

4. The workstation of claim 1, wherein the first and second portions are separated with respect to the second dimension such that the values for the specific feature extend in the second dimension continuously between the first and second portions.

5. The workstation of claim 1, wherein columns of the image array extend in the first dimension, and rows of the image array extend in the second dimension.

6. The workstation of claim 1, further comprising:
a display including a first display region to display the pixels using a colormap.

7. The workstation of claim 6, wherein the one or more processors are further configured to normalize, by a normalizing procedure, the features across the patients to generate the colormap.

8. The workstation of claim 7, wherein the normalizing procedure includes quantile normalizing.

9. The workstation of claim 8, wherein the normalizing procedure includes a linear normalizing executed after the quantile normalizing.

10. The workstation of claim 6, wherein the one or more processors are further configured to:
organize values of the features for a new patient having an unknown condition; and
insert pixels corresponding to the new patient into the array along the first dimension according to a value of the selected feature for the new patient; and
display the resulting colormap in the first display region.

11. The workstation of claim 10, wherein:
the display includes a second display region a second display region to display an image selected from the group consisting of: a medical image of the new patient, a subtraction image obtained from medical images of the new patient, a histogram, a kinetic curve, a collection of images of different patients that are similar to the new patient, and textual information describing the new patient.

12. The workstation of claim 1, further comprising:
a memory including data including one more of a medical image, medical image data, and data representative of a clinical examination, the one or more processors configured to extract the features, for one or more of the patients, from the data stored in the memory.

13. The workstation of claim 1, wherein the selected feature is a probability of malignancy.

14. A method, comprising:
generating an image array including a plurality of pixels, each of the pixels representing an image-based feature value of a patient obtained from imaging the patient, the image array including first and second dimensions so that pixels corresponding to a specific patient of a plurality of patients extend in the first dimension and pixels corresponding to a specific feature of a plurality of features extend in the second dimension;
grouping the patients represented in the image array into two or more groups, each of the groups indicating a known condition of the patients, such that patients having a first condition are part of a first group and are in a first portion of the array, and patients having a second condition are part of a second group and are in a second portion of the array; and
organizing, separately, each of the groups according to a selected feature of the features, such that the patients of the first group are arranged in an order of values for the selected feature within the first portion, and the patients of the second group are arranged in an order of values for the selected feature within the second portion.

15. The method of claim 14, further comprising:
obtaining values of the features for a new patient having an unknown condition; and
inserting pixels corresponding to the new patient into the array along the first dimension according to a value of the selected feature for the new patient.

16. The method of claim 14, wherein the first and second portions are separated with respect to the second dimension such that the values for the specific feature extend in the second dimension continuously between the first and second portions.

17. The method of claim 14, wherein columns of the image array extend in the first dimension, and rows of the image array extend in the second dimension.

18. The method of claim 14, further comprising:
normalizing the features across the patients to generate a colormap; and
displaying each of the pixels of the image array using a colormap, wherein
the normalizing is one or more of quantile and linear normalizing.

19. The method of claim 12, wherein the selected feature is a probability of malignancy.

20. A non-transitory computer readable storage medium including executable instructions, which when executed by a processor, cause the processor to execute a process comprising:
generating an image array including a plurality of pixels, each of the pixels representing an image-based feature value of a patient obtained from imaging the patient, the image array including first and second dimensions so that pixels corresponding to a specific patient of a plurality of patients extend in the first dimension and pixels corresponding to a specific feature of a plurality of features extend in the second dimension;
grouping the patients represented in the image array into two or more groups, each of the groups indicating a known condition of the patients, such that patients having a first condition are part of a first group and are in a first portion of the array, and patients having a second condition are part of a second group and are in a second portion of the array; and
organizing, separately, each of the groups according to a selected feature of the features, such that the patients of the first group are arranged in an order of values for the selected feature within the first portion, and the patients of the second group are arranged in an order of values for the selected feature within the second portion.
